(19) United States
(12) Patent Application Publication
(10) Pub. No.: US 2006/0090980 A1
(43) Pub. Date: May 4, 2006

(54) Wet type friction plate and method of producing the wet type friction plate

(75) Inventors: Yoshio Kinoshita, Fukuroi-shi (JP); Shiro Takeuchi, Fukuroi-shi (JP); Tatsuro Miyoshi, Fukuroi-shi (JP); Shigeki Umezawa, Kakegawa-shi (JP); Shun Kitahara, Fukuroi-shi (JP); Tamotsu Fujii, Hamamatsu-shi (JP); Hiroyuki Kinpara, Fukuroi-shi (JP); Kenji Maruo, Fukuroi-shi (JP); Tomoyuki Miyazaki, Kakegawa-shi (JP); Xiaoming Gu, Fukuroi-shi (JP); Fumimasa Muramatsu, Fukuroi-shi (JP); Shigeharu Nishimura, Kikugawa-shi (JP)

Correspondence Address: MILES & STOCKBRIDGE PC, 1751 PINNACLE DRIVE, SUITE 500, MCLEAN, VA, 22102-3833, US

(73) Assignee: NSK-WARNER K.K.

(21) Appl. No.: 11/258,134

(22) Filed: Oct. 26, 2005

(30) Foreign Application Priority Data
Oct. 28, 2004 (JP) 2004-314309

(51) Int. Cl. F16D 13/74; B32B 37/00

(52) U.S. Cl. 192/113.36; 156/265

(57) ABSTRACT

A wet type friction plate comprises symmetrical segments cut out of a frictional member, and pasted on the metallic core plate so as to form a groove which is gradually narrower from the inner diameter side to the outer diameter side. A method of producing the wet type friction plate, comprising the steps of cutting symmetrical segments out of a frictional member, and pasting the cut-out symmetrical segments on a metallic core plate so as to form a groove which is gradually narrower from the inner diameter side to the outer diameter side.

This application claims the benefit of Japanese Patent application No. 2004-314309 which is hereby incorporated by reference.

### BACKGROUND OF THE INVENTION

1. Field of the Invention

The present invention relates to a wet type friction plate of a wet multi-plate clutch which is used in an automatic transmission, frictional engagement device, or the like, and a method of producing the wet type friction plate.

2. Related Background Art

In order to improve the fuel efficiency of an automobile, it has been tried to reduce the drag which is generated when a part of an automatic transmission idles.

Also in a wet multi-plate clutch, in order to reduce the drag during idling, there is formed an oil groove which gradually becomes narrower from the inner diameter toward the outer diameter. It is found that, with this arrangement, an oil which is caused to flow toward the outer diameter by centrifugal force expands every wet type friction plates equally, which brings about great effect on the drag reduction.

As a result, in order to produce a wet type friction plate having an oil groove which is narrower from the inner diameter toward the outer diameter, according to the prior art, after a frictional member is applied on a metallic core plate, the frictional member is scraped by cutting or the groove is formed on the frictional member by pressing.

However, since the cut groove is formed narrower on the outer diameter side than on the inner diameter side, the cutting work is difficult and can not be performed with efficiency.

The groove formed by pressing also has a drawback that it has not sufficiently deep due to a recent trend of reduced thickness of the frictional member.

### SUMMARY OF THE INVENTION

Taking the circumstance as described above into consideration, an object of the present invention is to provide a wet type friction plate and a method of producing the wet type friction plate in which a groove having the same thickness as the frictional member and being gradually narrower from the inner diameter to the outer diameter can be formed with efficiency.

In order to achieve the above object, according to the present invention, there is provided a wet type friction plate in which symmetrical segments are cut out of a frictional member and said cut-out symmetrical segments are pasted on a metallic core plate so as to form a groove which is gradually narrower from the inner diameter side to the outer diameter side.

In the wet type friction plate of the present invention, it is preferable to form a groove which leads from the inner diameter to the outer diameter.

In the wet type friction plate of the present invention, it is preferable that the segments have mutually different sizes.

In the wet type friction plate of the present invention, it is preferable to form a groove having a closed end.

According to the present invention, there is provided a method of producing a wet type friction plate, comprising the steps of:

cutting symmetrical segments out of a frictional member; and

pasting said cut-out symmetrical segments on a metallic core plate so as to form a groove which is gradually narrower from the inner diameter side to the outer diameter side.

In the method of-the present invention, it is preferable to form a groove leading from the inner diameter to the outer diameter.

In the method of the present invention, it is preferable that the segments have mutually different sizes.

In the method of the present invention, it is preferable to form a groove having a closed end surface.

According to the present invention, the symmetrical segments are cut out of the frictional member, and the symmetrical segments are pasted on the metallic core plate so that the width of the groove becomes smaller from the inner diameter side to the outer diameter side. As a result, it is possible to form a groove which has the same thickness as the frictional member and which has a width becoming smaller from the inner diameter to the outer diameter with efficiency.

### BRIEF DESCRIPTION OF THE DRAWINGS

FIGS. 1A and 1B show a method of producing a wet type friction plate according to a first embodiment of the present invention, in which FIG. 1A shows a state that segments are pasted on a metallic core plate, and FIG. 1B shows a state that the segments are cut out;

FIGS. 2A and 2B show a method of producing a wet type friction plate according to a second embodiment of the present invention, in which FIG. 2A shows a state that segments are pasted on a metallic core plate, and FIG. 2B shows a state tat the segments are cut out;

FIGS. 3A and 3B show a method of producing a wet type friction plate according to a third embodiment of the present invention, in which FIG. 3A shows a state that segments are pasted on a metallic core plate, and FIG. 3B shows a state that the segments are cut out;

FIGS. 4A, 4B and 4C show a method of producing a wet type friction plate according to a fourth embodiment of the present invention, in which FIG. 4A shows a state that segments are pasted on a metallic core plate, FIG. 4B shows a state that the segments are cut out, and FIG. 4C shows one of the segments;

FIGS. 5A and 5B show a method of producing a wet type friction plate according to a first variation of the fourth embodiment of the present invention, in which FIG. 5A shows a state that segments are cut out, and FIG. 5B shows one of the segments; and

FIGS. 6A and 6B show a method of producing a wet type friction plate according to a second variation of the fourth embodiment of the present invention, in which FIG. 6A shows a state that segments are cut out, and FIG. 6B shows one of the segments.

### THE MOST PREFERRED EMBODIMENTS

Description will be made below of a wet type friction plate and a method of producing the wet type friction plate according to embodiments of the present invention with reference to drawings.

### FIRST EMBODIMENT

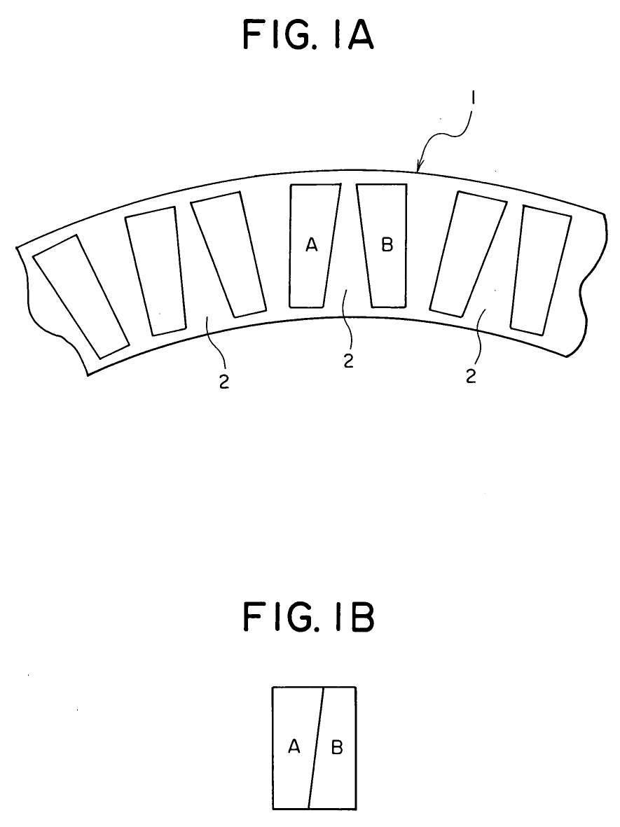

FIGS. 1A and 1B show a method of producing a wet type friction plate according to the first embodiment of the present invention, in which FIG. 1A shows a state that segments are pasted on a metallic core plate, and FIG. 1B shows a state that the segments are cut out.

In the first embodiment, symmetrical segments A and B are cut out of a blank member of frictional material. In this case, the symmetrical segments A and B are cut out of the blank member in a rectangular form along a slanting cutting line.

One of the symmetrical segments A and B is placed conversely or upside down, and the segments A and B are pasted on a metallic core plate 1 so as to form a groove 2 having the width which becomes gradually smaller from the inner diameter side to the outer diameter side. The groove 2 leads from the inner diameter to the outer diameter.

As described above, according to the first embodiment, it is possible to form the groove 2 having the same depth as the thickness of the frictional member and having the width which is gradually smaller from the inner diameter side to the outer diameter side, with efficiency.

### SECOND EMBODIMENT

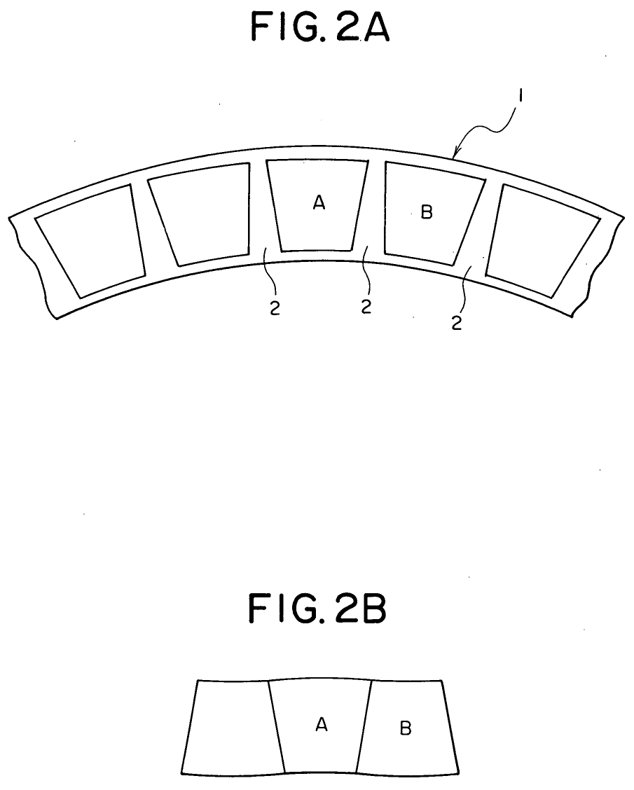

FIGS. 2A and 2B show a method of producing a wet type friction plate according to the second embodiment of the present invention, in which FIG. 2A shows a state that segments are pasted on a metallic core plate, and FIG. 2B shows a state that the segments are cut out.

In the second embodiment, symmetrical segments A and B are cut out of a blank member of frictional material. In this case, the symmetrical segments A and B are cut out of the blank member to have the form of a trapezoid or a fan.

One of the symmetrical segments A and B is placed conversely or upside down, and the segments A and B are pasted on a metallic core plate 1 so as to form a groove 2 having the width which becomes gradually smaller from the inner diameter side to the outer diameter side. The groove 2 leads from the inner diameter to the outer diameter.

As described above, according to the second embodiment, it is possible to form the groove 2 having the same depth as the thickness of the frictional member and having the width which is gradually smaller from the inner diameter side to the outer diameter side with efficiency.

### THIRD EMBODIMENT

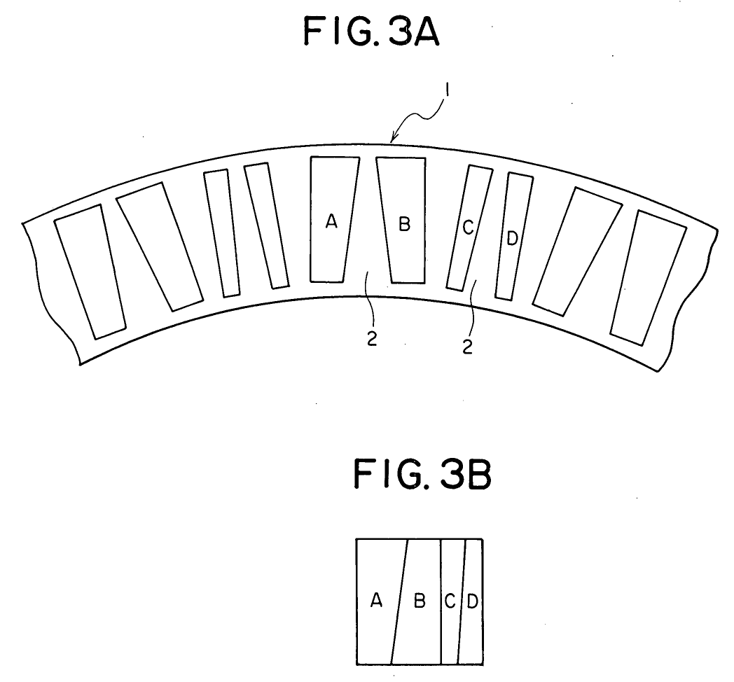

FIGS. 3A and 3B show a method of producing a wet type friction plate according to a third embodiment of the present invention, in which FIG. 3A shows a state that segments are pasted on a metallic core plate, and FIG. 3B shows a state that the segments are cut out.

In the third embodiment, symmetrical segments are cut out of a blank member of frictional material. In this case, four symmetrical segments A, B, C and D are cut out of the blank member in a rectangular form along a slanting cutting line, a straight cutting line and a slanting cutting line.

The segments A and B are symmetrical with each other, while the segments C and D are symmetrical with each other. However, the segments A and B are formed larger than the segments C and D.

One of the symmetrical segments A and B is placed conversely or upside down, and the segments A and B are pasted on a metallic core plate 1 so as to form a groove 2 having the width which becomes gradually smaller from the inner diameter side to the outer diameter side. The groove 2 leads from the inner diameter to the outer diameter.

On the other hand, one of the symmetrical segments C and D is placed conversely or upside down, and the segments C and D are pasted on a metallic core plate 1 so as to form a groove 2 having the width which becomes gradually smaller from the inner diameter side to the outer diameter side. The groove 2 leads from the inner diameter to the outer diameter.

As described above, according to the third embodiment, it is possible to form the groove 2 having the same depth as the thickness of the frictional member and having the width which is gradually smaller from the inner diameter side to the outer diameter side with efficiency.

### FOURTH EMBODIMENT

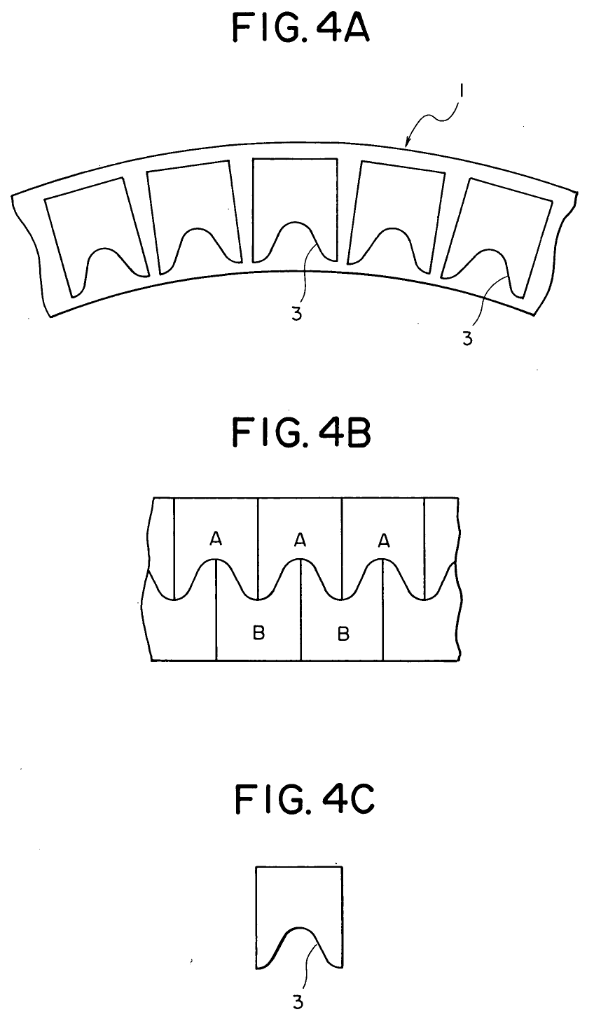

FIGS. 4A, 4B and 4C show a method of producing a wet type friction plate according to the fourth embodiment of the present invention, in which FIG. 4A shows a state that segments A and B are pasted on a metallic core plate 1, FIG. 4B shows a state that the segments are cut out, and FIG. 4C shows one of the segments.

In the fourth embodiment, symmetrical segments A and B are cut out of a blank member of frictional material. In this case, the symmetrical segments A and B are cut out of the blank member along straight cutting lines from above and from below alternately in the vertical direction and along an arched wave-formed cutting line in the horizontal direction.

In this manner, the symmetrical segments A and B each having a groove 3 with a closed end can be obtained.

The symmetrical segments A and B are successively placed, and pasted on a metallic core plate 1 so as to form the grooves 3 each with a closed end.

As described above, according to the fourth embodiment, it is possible to form the grooves 2 each having a closed end with efficiency.

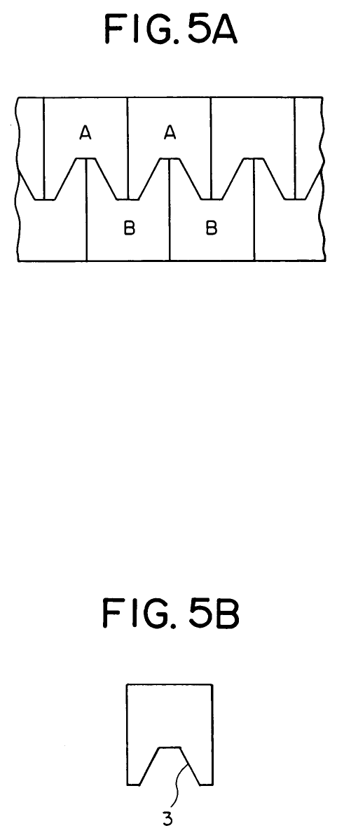

FIGS. 5A and 5B show a method of producing a wet type friction plate according to a first variation of the fourth embodiment of the present invention, in which FIG. 5A shows a state that segments are cut out, and FIG. 5B shows one of the segments.

This variation is basically the same as the fourth embodiment, except that the symmetrical segments A and B are cut out along a rectangular wav-formed line consisting of slanting lines and straight lines, instead of the arched wave-formed cutting line, in the horizontal direction. In this manner, the symmetrical segments A and B having the grooves 3 each with a closed end can be obtained. Other structures, operations and effects are the same as those in the fourth embodiment described above.

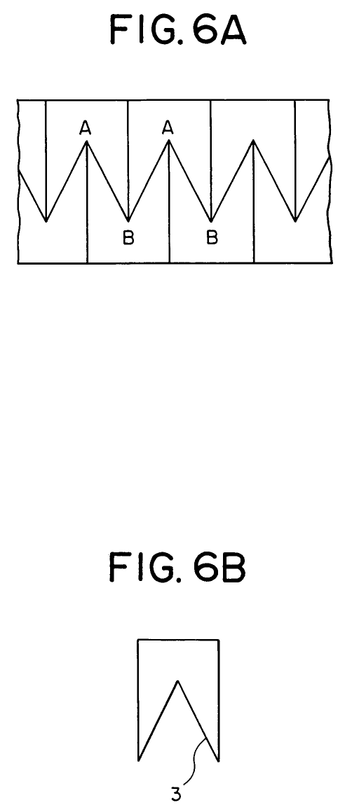

FIGS. 6A and 6B show a method of producing a wet type friction plate according to a second variation of the fourth embodiment of the present invention, in which FIG. 6A shows a state that segments are cut out, and FIG. 6B shows one of the segments.

This variation is basically the same as the fourth embodiment, except that the symmetrical segments A and B are cut out along rectangular a wave-formed line consisting of slanting lines, instead of the arched wave-formed cutting line, in the horizontal direction. In this manner, the symmetrical segments A and B having the grooves 3 each with a closed end can be obtained. Other structures, operations and effects are the same as those in the fourth embodiment described above. The segments described above can be successively cut out of a belt-formed or plate-formed frictional member.

Note that the present invention is not limited to the embodiments described above, but can be changed in various manners.

What is claimed is:

1. A wet type friction plate comprising:
a metallic core plate;
symmetrical segments cut out of a frictional member; and
pasted on the metallic core plate so as to form a groove which is gradually narrower from the inner diameter side to the outer diameter side.

2. A wet type friction plate according to claim 1, wherein a groove which leads from the inner diameter to the outer diameter is formed.

3. A wet type friction plate according to claim 2, wherein the segments have mutually different sizes.

4. A wet type friction plate according to claim 1, wherein a groove having a closed end is formed.

5. A method of producing a wet type friction plate, comprising the steps of:
cutting symmetrical segments out of a frictional member; and
pasting said cut-out symmetrical segments on a metallic core plate so as to form a groove which is gradually narrower from the inner diameter side to the outer diameter side.

6. A method according to claim 5, wherein a groove leading from the inner diameter to the outer diameter is formed.

7. A method according to claim 6, wherein the segments have mutually different sizes.

8. A method according to claim 5, wherein a groove having a closed end surface is formed.
